(19) United States
(12) Patent Application Publication
(10) Pub. No.: US 2013/0134764 A1
(43) Pub. Date: May 30, 2013

(54) VEHICLE COMFORT SEAT

(71) Applicant: Rhonda Groh, Lake Zurich, IL (US)

(72) Inventor: Rhonda Groh, Lake Zurich, IL (US)

(21) Appl. No.: 13/304,648

(22) Filed: Nov. 26, 2011

(51) Int. Cl. B60N 2/44

(52) U.S. Cl. 297/452.41

(57) ABSTRACT

The present invention is a vehicle comfort seat utilized in a vehicle that includes a base vehicle, seat installed in the vehicle that includes a lumbar region and a bottom cushion with a side, a top surface and a front and a plurality of air-filled cushions that are disposed on the top surface and the front of the bottom cushion, wherein the air-filled cushions are disposed on the top surface and the front of the bottom cushion without being disposed on the lumbar region of the base vehicle seat. The pneumatic power source is incorporated into the vehicle's system to provide compressed air to inflate and deflate the air-filled cushions and a controlling device is provided that controls a predetermined amount and a predetermined pressure of compressed air to the air-filled cushions.

### TECHNICAL FIELD & BACKGROUND

Conventional seating in a motor vehicle is generically formulated and comes standard from the manufacturer, offering little support on lengthy or stressful trips. Currently there are limited alternatives to motor vehicle seats which present an individual with a plurality of variable firmness settings while driving.

The present invention generally relates to a comfort seat. More specifically, the invention is a motor vehicle comfort seat.

It is an object of the invention to provide a motor vehicle comfort seat that provides comfort and support on a front and top surface of a bottom cushion of the motor vehicle comfort seat.

It is an object of the invention to provide a motor vehicle comfort seat that is pneumatically controlled to provide a plurality of numeric comfort settings.

It is an object of the invention to provide a motor vehicle comfort seat that utilizes a push button that can be depressed one or more times thereby controlling the amount of compressed air and relative softness or relative firmness of the front and top surface of a bottom cushion of the motor vehicle comfort seat.

What is really needed is a motor vehicle comfort seat that provides comfort and support on a front and top surface of a bottom cushion of the motor vehicle comfort seat that is pneumatically controlled to provide a plurality of numeric comfort settings and that utilizes a push button that can be depressed one or more times thereby controlling the amount of compressed air and relative softness or relative firmness of the front and top surface of the bottom cushion of the motor vehicle comfort seat.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front perspective view of a vehicle comfort seat, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

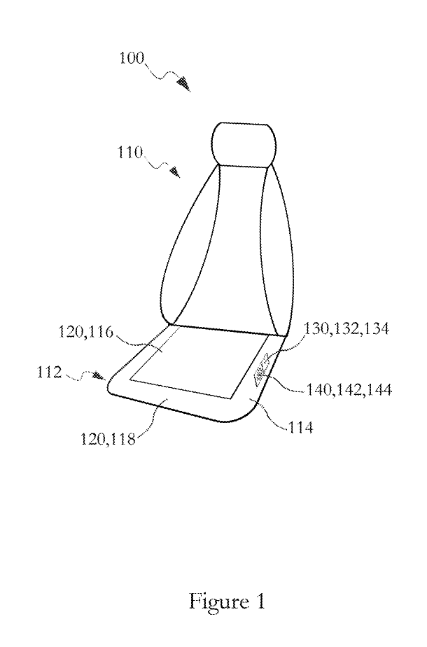

FIG. 1 illustrates a front perspective view of a vehicle comfort seat 100, in accordance with one embodiment of the present invention.

The vehicle comfort seat 100 includes a base vehicle seat 110, a plurality of air-filled cushions 120, a pneumatic power source 130 and a controlling device 140. The base vehicle seat 110 includes a bottom cushion 112 with a side 114, a top surface 116 and a front 118. The base vehicle seat 110 is typically a standard vehicle seat installed in a vehicle such as an automobile, a pick-up truck, a van, a recreational vehicle or a commercial truck, although any suitable standard vehicle seat can be utilized with the vehicle comfort seat 100. The air-filled cushions 120 are disposed on the top surface 116 and the front 118 of the bottom cushion 112 without being disposed on the lumbar region 111 of the base vehicle seat 110. The pneumatic power source 130 is typically a pneumatic pump 132 that is incorporated into the vehicle's system, although a supplemental pneumatic pump 134 or other suitable pneumatic power source 130 can also be utilized to provide compressed air to inflate and deflate the air-filled cushions 120. The controlling device 140 controls a predetermined quantity and predetermined amount of pressure of compressed air being provided to the air-filled cushions 120. The controlling device 140 includes a push button 142 that controls a plurality of numeric comfort settings 144 that control the amount and pressure of compressed air coming from the pneumatic power source 130 being pumped into the air-filled cushions 120. The push button 142 can be depressed one or more times thereby controlling the amount of compressed air and relative softness or relative firmness of the air-filled cushions 120. The more compressed air being pumped into the air-filled cushions 120, the relatively firmer the air-filled cushions 120 will be. In other words, the predetermined amount and the predetermined pressure of the compressed air are proportional to the firmness of the air-filled cushions 120. The controlling device 140 operates in a similar fashion to a sleep number controlled mattress where the higher the sleep number entered, the firmer the mattress will be.

The vehicle comfort seat is a pneumatic powered seat that is designed with a plurality of adjustable air-filled cushions, conveniently molded to an individual's specific requirements and features. Each vehicle comfort seat is equipped with a controlling device with a plurality of various settings managed by a push button that is integrated directly into the vehicle comfort seat. The vehicle comfort seat is relatively easy to operate and includes a plurality of cushions that has the capability to be controllably inflated and deflated, conforming to the user's body to enhance comfort and alleviate discomfort. The vehicle comfort seat affords each individual the luxury of a relatively softer or relatively more firm seating structure while traveling in an automobile with the utilization of a plurality of pneumatic powered cushions, which can be wired directly into a vehicle's seat and powered through the vehicle's electrical system.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A vehicle comfort seat utilized in a vehicle, comprising:
a base vehicle seat installed in said vehicle that includes a lumbar region and a bottom cushion with a side, a top surface and a front;
a plurality of air-filled cushions that is disposed on said top surface and said front of said bottom cushion;
a pneumatic power source that is incorporated into said vehicle's system to provide compressed air to inflate and deflate said air-filled cushions; and
a controlling device that controls a predetermined amount and a predetermined pressure of said compressed air being provided to said air-filled cushions with a push button.

2. The vehicle comfort seat according to claim 1, wherein said air-filled cushions are disposed on said top surface and said front of said bottom cushion without being disposed on said lumbar region of said base vehicle seat.

3. The vehicle comfort seat according to claim 1, wherein said pneumatic power source is a pneumatic pump.

4. The vehicle comfort seat according to claim 1, wherein said pneumatic power source is a supplemental pneumatic pump.

5. The vehicle comfort seat according to claim 1, wherein said predetermined amount and said predetermined pressure of said compressed air is proportional to said firmness of said air-filled cushions.

6. The vehicle comfort seat according to claim 1, wherein said vehicle is an automobile.

7. The vehicle comfort seat according to claim 1, wherein said vehicle is a pick-up truck.

8. The vehicle comfort seat according to claim 1, wherein said vehicle is a van.

9. The vehicle comfort seat according to claim 1, wherein said vehicle is a recreational vehicle.

10. The vehicle comfort seat according to claim 1, wherein said vehicle is a commercial truck.

11. A vehicle comfort seat utilized in a vehicle, comprising:
a base vehicle seat installed in said vehicle that includes a lumbar region and a bottom cushion with a side, a top surface and a front;
a plurality of air-filled cushions that are disposed on said top surface and said front of said bottom cushion, wherein said air-filled cushions are disposed on said top surface and said front of said bottom cushion without being disposed on said lumbar region of said base vehicle seat;
a pneumatic power source that is incorporated into said vehicle's system to provide compressed air to inflate and deflate said air-filled cushions; and
a controlling device that controls a predetermined amount and a predetermined pressure of said compressed air being provided to said air-filled cushions with a push button, wherein said push button controls a plurality of numeric comfort settings that control said predetermined amount and said predetermined pressure of compressed air coming from said pneumatic power source being pumped into said air-filled cushions.

12. The vehicle comfort seat according to claim 11, wherein said pneumatic power source is a pneumatic pump.

13. The vehicle comfort seat according to claim 11, wherein said pneumatic power source is a supplemental pneumatic pump.

14. The vehicle comfort seat according to claim 11, wherein said predetermined amount and said predetermined pressure of said compressed air is proportional to said firmness of said air-filled cushions.

15. The vehicle comfort seat according to claim 11, wherein said push button is depressed a plurality of times thereby controlling said predetermined amount and said predetermined pressure of compressed air and softness or firmness of said air-filled cushions.

16. The vehicle comfort seat according to claim 11, wherein said vehicle is an automobile.

17. The vehicle comfort seat according to claim 11, wherein said vehicle is a pick-up truck.

18. The vehicle comfort seat according to claim 11, wherein said vehicle is a van.

19. The vehicle comfort seat according to claim 11, wherein said vehicle is a recreational vehicle.

20. The vehicle comfort seat according to claim 11, wherein said vehicle is a commercial truck.
